(19) United States
(12) Patent Application Publication
(10) Pub. No.: US 2016/0103859 A1
(43) Pub. Date: Apr. 14, 2016

(54) Systems and Methods for Segmentation By Object in Data Sets

(71) Applicant: Simularity, Inc., Richmond, CA (US)

(72) Inventors: Raymond Richardson, Richmond, CA (US); Elizabeth DERR, Richmond, CA (US)

(21) Appl. No.: 14/883,104

(22) Filed: Oct. 14, 2015

Related U.S. Application Data
(60) Provisional application No. 62/063,742, filed on Oct. 14, 2014.

(51) Int. Cl. G06F 17/30

(52) U.S. Cl. CPC G06F 17/30292

(57) ABSTRACT

Described is a system and method for storing a plurality of data points in a form Subject->Object and Object->Subject, where subject and object are differently typed entities, wherein the data points are stored in a plurality of segments, performing an expression search in each segment to identify an expression set of objects or subjects which can be viewed as the right hand side of the expression, determining, for each segment, actions corresponding to each of the data points in the expression set, determining a count of each of the actions and applying a metric to each of the expression set, the actions and the count to obtain a result.

### PRIORITY CLAIM/INCORPORATION BY REFERENCE

This application claims priority to U.S. Provisional Application 62/063,742 entitled “Segmentation By Object,” filed on Oct. 14, 2014, the entirety of which is incorporated herein by reference.

### BACKGROUND

Predictive analytics that are used to analyze large sets of data suffer from many drawbacks. For example, predictive analytics have rigid data structure requirements and the data must be from a single source. Also, predictive analytics need a small, static data set. Thus, predictive analytics techniques use sampling rather than full data sets due to the computational intensity of the techniques. Predictive analytics techniques also require historical training sets. Therefore, predictive analytics techniques do not adapt and respond to new information in real-time. Predictive analytics require experts. While predictive analytics and machine learning are powerful, they require expensive experts to develop, deploy, maintain. These experts are difficult to find, and are scarce resources, so wait-time for analyses can be months. Current predictive analytics are difficult to understand. For example, predictive models used for scoring are black boxes that are nearly impossible to explain. Predictive analytics are not widely used in data-driven decision making because decision makers do not understand or trust the models.

Predictive analytics are not ready for Internet Of Things (“IOT”) use cases. Nearly all predictive analytics solutions are based on Hadoop, which is a batch-oriented solution not suitable for real-time analysis. Predictions based on time series data and geo-spatial data are particularly challenging. Predictive analytics techniques cannot adapt and respond in real-time to the flood of information generated by connected devices.

### SUMMARY

The exemplary embodiments include a system and method for storing a plurality of data points in a form Subject->Object and Object->Subject, where subject and object are differently typed entities, wherein the data points are stored in a plurality of segments, performing an expression search in each segment to identify an expression set of objects or subjects which can be viewed as the right hand side of the expression, determining, for each segment, actions corresponding to each of the data points in the expression set, determining a count of each of the actions and applying a metric to each of the expression set, the actions and the count to obtain a result.

### BRIEF SUMMARY OF THE DRAWINGS

FIG. 1 shows a platform overview of an exemplary embodiment of a High Performance Correlation Engine (HPCE).

FIG. 2 shows an example of how the HPCE uses triples to determine similarities and correlations.

FIG. 3 shows an exemplary integration of the exemplary HPCE with a user's system and data.

FIG. 4 shows the four (4) basic values calculated by the HPCE in a graphical set format.

FIG. 5 is an exemplary method for performing a correlation search by the HPCE.

FIG. 6 shows a graphic representation of an example faceted expression search performed by the HPCE.

FIG. 7 shows a graphic representation of an example action search performed by the HPCE.

### DETAILED DESCRIPTION

The exemplary embodiments may be further understood with reference to the following description and the appended drawings, wherein like elements are referred to with the same reference numerals. The exemplary embodiments describe a High Performance Correlation Engine (HPCE) that is a purpose-built analytics engine for similarity and correlation analytics optimized to do real-time, faceted analysis and discovery over vast amounts of data on small machines, such as laptops and commodity servers.

The HPCE is an efficient, easy to implement, and cost-effective way to use similarity analytics across all available data, not just a sample. Similarity analytics can be used for product recommendations, marketing personalization, fraud detection, identifying factors correlated with negative outcomes, to discover unexpected correlations in broad populations, and much more.

Similarity analytics are the best analysis tool for discovery of insights from big data. The value is in getting the data to reveal new insights. This is a challenge best solved by looking for connections in the data. However, standard analytics that come with a data warehouse do not provide this functionality. In addition, performing this type of discovery over large datasets is cost-prohibitive with standard analytics packages. Without similarity analytics, assumptions about the answers need to be made before questions are asked, i.e., you have to know what you're looking for.

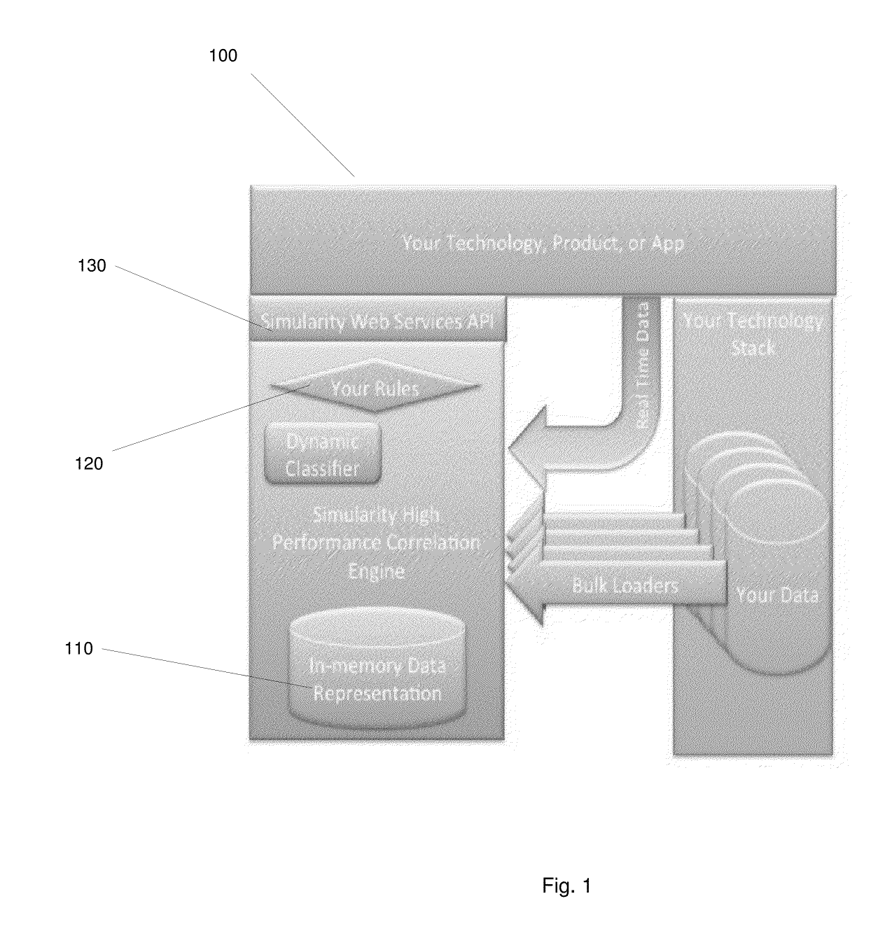

FIG. 1 shows a platform overview 100 of an exemplary embodiment. The exemplary embodiments provide a highly compact, in-memory representation 110 of data specifically designed to do similarity analytics. In addition, the exemplary embodiments provide a flexible logic-programming layer to enable completely customized business rules 120, and a web services layer 130 on top for easy integration with any website or browser-based tool. This unique data representation allows real-time faceting of the data, and the web services layer (API) 130 makes including correlations in systems, technology, or applications easy.

One manner in which programs and systems interact and derive value from the HPCE is via Correlation searches. A Correlation search specifies a subset of the data to be examined or a key data element, the data type for which to calculate correlations, and the correlation metric to be used. For example, the problem may be defined as attempting to find products correlated with a key product to generate recommendations of the form “people who bought this also bought these other things.” In this Correlation search, the key would be the key product, the data type for which to calculate correlations is products, and the metrics may be defined as a log-likelihood. The results will be a list of products correlated with the key product, and their corresponding log-likelihood value, ordered by strength of correlation, strongest first.

In a different scenario, the problem may be defined as examining whether there is any seasonality to a particular event type, such as customers terminating their subscriptions to a service. In this Correlation search, the subset of the data to be examined is the set of customers who have terminated their subscriptions, the data type for which to calculate correlations would be the month of their termination, and the metrics may be defined as a p-value, which is an indication of the probability of a correlation. The results will be a list of months, and their corresponding p-value, ordered by strength of correlation, strongest first.

A faceted search is a technique for accessing information organized according to a faceted classification system, allowing users to explore a collection of information by applying multiple filters. Similar to faceted search, faceting in correlations allows multiple ways to specify a subset of the data to consider. The HPCE has several mechanisms that can be used in combination to create faceted correlations: complex expressions, type subsets, and action subsets.

The HPCE also supports complex expressions to identify the subset. An expression comprises of either object specifications or subject specifications (but not both) joined by basic set operations Union (+) Intersection (*) Difference (−) and Symmetric Difference (/) as well as expressions that select objects with ranges of timestamps, or relative displacements in time. An expression yields a Set of items, which are of the opposite class as the expression (i.e. if the expression consists of object items, the resultant set is of subjects). For example, to examine factors correlated with people who have been diagnosed with both diabetes and hypertension, an exemplary complex expression such as the following may be used:
a. (people with diabetes diagnosis codes 1 or 2 or 3 or 4) and (people with hypertension diagnosis codes 5 or 6 or 7 or 8 or 9)

To look at this same group, but exclude people who are over 65, an exemplary complex expression such as the following may be used:
a. (people with diabetes diagnosis codes 1 or 2 or 3 or 4) and (people with hypertension diagnosis codes 5 or 6 or 7 or 8 or 9) and not (age greater than 65)

The HPCE also allows the types of objects or subjects to be considered when determining the correlation metric. For example, when creating recommendations for a particular product type, e.g., a food item, it may be desired to specify that only products of particular types (such as other food items) be used to determine correlated products, even if people who liked this food item might also have liked movies and books.

In addition, it is possible to specify which types of objects that should be in the results, e.g., if the key product is a health and beauty item, such as a lipstick, the results may be specified to only include correlated items that are also health and beauty items, even if there are products that are not health and beauty items that were also purchased by customers who purchased this product.

In a further example, it may be desired to specify a subset of actions that are considered in determining correlations. For example, it may be specified to include all positive actions (such as liked, loved, bought, 4 star review, 5 star review, added to cart, added to wishlist, etc.) when creating product recommendations, and exclude negative actions (such as disliked, one or two star reviews, returned, complained, etc.). It may further be considered that different sets of recommendations may be created such as “people who viewed this item also viewed” and “people who bought this time also bought.” This can be done by specifying which actions to consider in the Correlation search.

The data representation used by the HPCE is designed to be a general-purpose methodology for representing information, as well as an efficient model for computing correlations. Virtually any structured and semi-structured data can be represented by the exemplary data representation, and the data can be loaded from any data source. For example, data can be loaded from relational databases, CSV files, NoSQL systems, HDFS, or nearly any other representation can be loaded into the exemplary data representation via loader programs. The loading of data happens externally to the HPCE over a socket or web services interface, so users can create their own data loaders in any programming language.

The loader will take the data in its existing form (for example a relational table in an RDBMS) and turn it into triples that can be used by the HPCE. Triples are of the form Subject/Action/Object. For example “Liz likes Stranger in a Strange Land” is a triple, where “Liz” is the subject, “likes” is the action, and “Stranger in a Strange Land” is the object. Because the internal data representation is very compact, many data points can be simultaneously loaded into memory or cached, which helps the HPCE achieve its high performance.

Thus, the HPCE may be referred to as a Segmented Semantic Triplestore because, as described above, it is a database of triples of the form Subject/Action/Object. It is segmented in the sense that this database is stored on some number of segments, communicating processes that may be on different servers that store a portion of the data. The algorithm that determines on which segment a particular triple resides is a central component of the exemplary system. The triplestore is not a general purpose database, but is rather designed to efficiently perform a few operations as described herein.

Each triple is composed of typed components: each subject is of a subject type and each object is of an object type. The triplestore is most useful when data is added to it in a schema that describes the relationship between subject types and object types, as well as the actions that connect them. To carry through with the above example that may be better expressed as Customer:Liz likes Book:Stranger In a Strange Land. The types and actions are used to include or exclude results from a correlation search, and to change how items in the database are considered when a correlation search is executed. By using types and actions, many kinds of data can be represented, and correlations computed using many different models for selecting what is considered.

The triplestore schema can be constructed in such a way that the data in the triplestore is isomorphic with a relational database. In such a schema, subject types represent tables, object types represent fields, actions are limited (often to one action, the ubiquitous “attribute”), subject values represent a primary key of the record, and object values represent the values of their respective fields. This is not the only way the triplestore can be constructed, but it is a valuable way to represent the data. One difference between the triplestore and a relational database is that in the triplestore, there may be more than one value associated with a particular type, whereas in a relational database, each field contains at most one value. Of course, one can make the values associated with a type unique, simply by controlling the addition of the data.

The exemplary embodiments add types to objects and subjects to allow faceting. Subject types are the types associated with subjects, object types are likewise the types associated with objects; each subject and object may have a type. Subject types and object types are inherently different, so while the names that these types have may be different, they may use the same underlying numerical representation.

In deciding what components of the data are subjects, it should be remembered that correlations are typically computed between Subjects or between Objects, i.e. a correlation may be computed between a book and a movie (both objects) or between two customers (both subjects). It is possible to compute a correlation between a customer and a book (Subject/Object correlation). This is a different operation than the discovery of basic correlations. In general, both subjects and objects can be viewed as records, the fields of objects are subjects, and the fields of subjects are objects, thus correlations can be easily computed between fields.

Actions may also be thought of as relationships connecting subjects to objects. Examples of actions include “likes,” “added to wishlist,” “is a friend of,” “has a”. Actions are specific to an HPCE installation, and can be completely defined by the implementation. Actions have reciprocal relationships, such as “likes” and “is liked by”, although both are generally referred to by the same name. Actions can be used to filter the operations which are considered when a correlation is computed, for example, when calculating product recommendations, all of these actions: bought, likes, loves, added to wishlist, and added to cart, may be considered.

Actions may be forward, reverse, or both. A forward action is a subject acting on an object; likewise, a reverse action is an object acting on a subject. When specifying actions in a correlation search, the default is to consider both, however, it is possible to consider only a forward or reverse action.

To denote a subject or object textually, it may be written as object(type, item), or subject(type, item). While it is not usually a good idea, subject types and object types are non-intersecting, so the same identifiers can be used as both subject and object types without conflict. It is possible to textually denote subjects and objects in queries of the triplestore. A simple rule for textually denoting strings is that if the type or item is represented by the internal ID number (an integer), then that integer should never be quoted. If the type or item is represented by a symbol (string) then that string should be enclosed in single quotes. For example, object(1, 12345) is correct, and object(‘customer_id’, ‘Bob Johnson’) is correct (as well as object(1, ‘Bob Johnson’). The denotation object(‘1’, ‘Bob Johnson’) could be correct, if ‘1’ is the name (not number) of an object type, however, this is almost never the case.

The triplestore may be queried using a query language that is based on the Prolog programming language. When querying for correlations, an expression may be used to state the set of circumstances with which to find correlations. For example, the query object(‘diagnosis’, ‘diabetes’) & object(‘diagnosis’, ‘heart disease’) finds those things (objects) correlated with both a diagnosis of diabetes and a diagnosis of heart disease. The query may also be used to find which subjects have actions on both a diagnosis of heart disease and a diagnosis of diabetes (this is not a correlation, but rather a simple relationship).

Objects in the triples are Boolean, that is, they either exist or do not; they do not contain any other values. They can, however, represent a value associated with a type, and can be queried by range. Thus a type could exist to describe a customer called CUSTOMER_AGE, the item value would be an integer representing the age in years (or any other time span) of the customer. Ranges could be queried using a range expression of the form object(‘CUSTOMER_AGE’, 0, 17), which would match every customer aged 0-17. Open ended ranges can be constructed using the maximum and minimum object values, for instance object(‘CUSTOMER_AGE’, 90, 0×ffffffff), would refer to anyone over 90. Types can also be specified to use floating point values. These floating point values are useful for constructing expressions rather than as targets of correlations.

Another way to construct bins from continuous values is via mean and standard deviation. For example, if there is a Body Mass Index value for each patient in the data, e.g., 26.7, bins may be created to identify how far away each patient is from the average. In this manner, analysis may be performed on patients that are significantly above or below average. This may be done by calculating the mean and standard deviation for this value across the data set. Objects may then be created for the standard deviations that are positive and negative integers. Then, for each patient, an object may be added that indicates how many standard deviations their BMI is from the mean (rounded to an integer).

Requests can be constructed that use multiple objects. For example, this would allow correlations corresponding to everyone over 18, who is also male (as well as any number of other constraints). Time may also be structured in the same way. The system may contain multiple representations of time (Number of seconds, days, months, years or any other measure of time). As long as they are distinguished by differing types, multiples of these time representations may have actions on a single subject.

It is possible to have a bin granularity so small that each object only corresponds to one subject; such objects would not be useful for computing correlations, however, they could be used in rules to include or exclude results from a correlation search. If correlation searches are desired for timestamps (or timestamp ranges), the specified timestamps must include multiple objects; for the most part, the more objects (or subjects) in a specified by a query, the more effective it is for computing correlations.

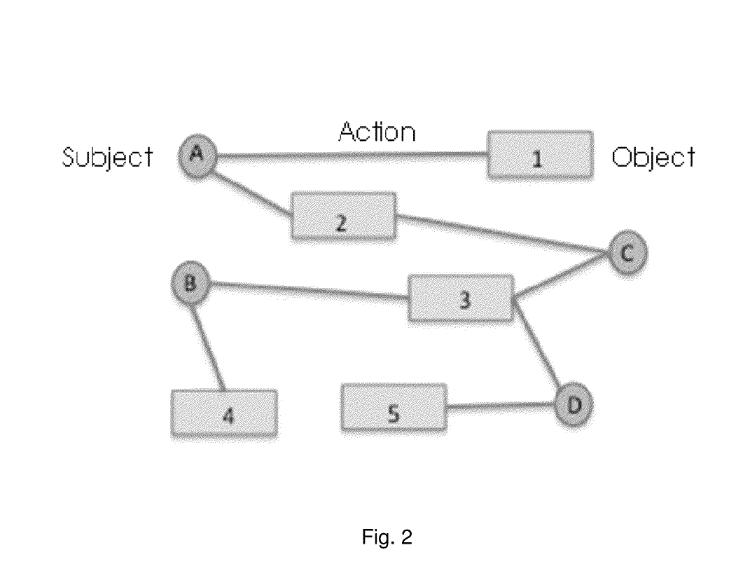

FIG. 2 shows an example of how the HPCE uses the triples to determine similarities and correlations. This process may be referred to as a “fold,” in that the process “folds” through the objects that the subject (or set of subjects) has acted on to get the subjects that have also acted on those objects and are thus correlated. The process may also fold from an object through subjects to obtain correlated objects. In FIG. 2, the data representation is shown as subjects with circles having letters, actions as lines, and objects as rectangles having numbers. From this diagram we can see that subject A has acted (whatever the action might be) on objects 1 and 2, subject B has acted on objects 3 and 4, etc. To get all the subjects that are similar to (or correlated with) subject A, the HPCE obtains the objects that A has acted on, 1 and 2, and then finds the subject(s) that have also acted on those objects, in this example just subject C, to which the correlation metrics will be applied.

Likewise, to find all the objects that are similar to (or correlated with) object 2, the HPCE obtains all the subjects that have acted on object 2, A and C, and then finds the object(s) that they have also acted on, 1 and 3 in this case, to which the correlation metrics will be applied.

The HPCE may present a RESTful web services layer to clients. Requests may be represented as a URI, and responses may be in JSON. The following provide several examples of correlation searches that can be specified via web services:
a. Get the correlation value between two specified subjects or objects. Example: determine how similar two users are to one another.
b. Get the set of N objects correlated with a key object, and the correlation values. Example: find the N most correlated products to a key product.
c. Get the set of N subjects correlated with a key subject and the correlation value.

Example: find the N most similar users to a key user.
d. Get the set of N objects correlated with a key subject. Example: get N products that are recommended for a specific user.

The following provides a specific example of an API call. For this example, the data set may be MovieLens data. Actions are created for each of the possible star ratings for movies, e.g., the “rated5” action means the user rated the movie 5 stars. The basic web service call to the HPCE is /expression, which obtains correlations to a set of items specified by an expression. It may be performed via an HTTP Post, where the contents of the post data define the expression. The following is a sample URL:
a. http://localhost:3000/expression?action=rated4&action=rated5&otype=movie&stype=user&metric=log_likelihood&legit=5&count=10&use_legit=true
b. with a post data of “object(movie, 260)”

This sample call would retrieve the top 10 (count=10) correlated movies (otype=movie) for movie number 260 (object(movie, 260)) using users as the inner fold (stype=user) where each result has at least 5 ratings (legit=5&use_legit=true), considering only actions that are 4 or 5 star ratings (action=rated4&action=rated5), using log_likelihood as the correlation metric (metric=log likelihood).

The following provides an exemplary parameter list for the service call /expression.

stype=X This is the Subject Type to match in a fold. X is either a type number, or a symbol defining a type. Any number of stype parameters can be specified.

otype=X This is the Object Type to match in a fold. X is either a type number or a symbol. Any number of otype parameters can be specified.

action=X This is the Action to consider in the fold. When “action” is specified (rather than “faction” or “raction”), X is a both a forward and reverse action. X is a string or action number that specifies an action in both directions (subject to object and object to subject). Any number of action parameters can be specified.

faction=X This is the Action to consider in the fold. X is a string or action number that specifies a forward action (subject to object). Any number of faction parameters can be specified.

raction=X This is the Action to consider in the fold. X is a string or action number that specifies a reverse action (object to subject). Any number of raction parameters can be specified.

use_legit=Bool This indicates whether or not to use the legit parameter. If the string is “true” then the legit parameter will be used instead of the hard limit of 10 result actions (see legit). Absence, or any value other than true means a minimum of 10 will be applied to matching result actions.

count=X Count indicates the number of results to return and is a required parameter. No more than X results (where X is an integer) will be returned.

metric=X Metric specifies which metric to use. X is a string. If not specified, then the default is log_likelihood.

legit=X Legit indicates the minimum legitimate matching action count for a result to be used. This value is always enforced. If use_legit is not set to true, an additional minimum enforcement is done which requires at least ten expression results, at least 10 actions on a result, and at least 10 items in common between the 2.

As described above, the HPCE has the option of using several different similarity or correlation metrics. The metric to be used is specified in the correlation search. The following provides some exemplary correlation metrics, but those skilled in the art will understand that other metrics may also be used. As in any correlation search in the HPCE, the set of types and actions to be considered can be fully specified. Metrics that are symmetric will give you the same number, regardless of the order of the items (i.e. the similarity of A to B is the same as the similarity of B to A in symmetric metrics). Examples of correlation metrics include Upper P-value, Lower P-value, Cosine Similarity, Sorensen Similarity Index, Jaccard Index, Log-likelihood Ratio, etc. New correlation metrics are easy to add to the system.

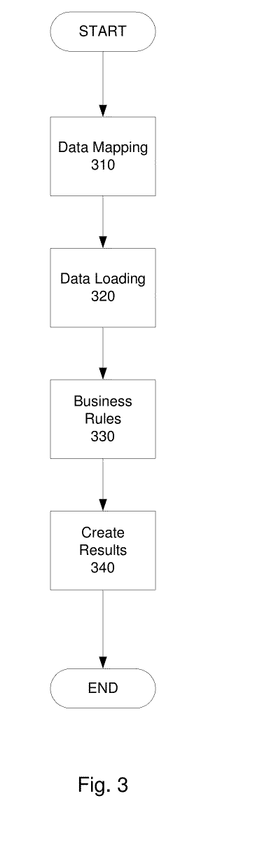

FIG. 3 shows an exemplary integration 300 of the exemplary HPCE with a user's system and data. In step 310, the user's data is mapped. This involves determining how the user's data should be represented as triples in the HPCE. This means separating the data into subjects and objects, and separating those subjects and objects into appropriate types.

Sometimes this partitioning is obvious: in-store and internet customers are subjects of two types and products are objects, with varying types. The partitioning may not always be this obvious, however. For example, in the case of an internet user's zip code, that zip code would be an object (it's an attribute of a subject, probably of type ZIP_CODE). In the case of including the warehouses where products are located, the warehouse would be a subject (it's an attribute of an object). A subject/subject correlation search may then be performed between an internet user and warehouses, to find the warehouses most correlated to (used by) a particular user, or, perhaps more interestingly, the other way.

In step 320, data loading occurs. The data may be loaded as batches and/or in a streaming manner. In batch loading, the data in the HPCE comes from an external loader program. The loader reads from some data store (e.g., see FIG. 1), such as a relational database, text files, or any other data source, and transforms it into the triples. These triples are then added to the HPCE by calling a web service, or by connecting to a TCP socket. It should be noted that any programming language can be used to write a loader; if specialized libraries are required to read a data source, the programming language need only be able to write to a socket in order to load the data.

Once the HPCE is operational, additional data may be added to the HPCE at any time in a streaming manner. By simply connecting to the HPCE's loader socket or calling the web service, new data can be written (or deleted) in real time. The data can be updated continuously without interfering with ongoing correlation searches. Each new correlation search will use the latest data.

In step 330, business rules are applied. A user may determine which, if any, business rules to apply to filter the results of the correlation searches. There may be arbitrarily many rules, and these rules act as filters or modifiers to correlation results that have already been determined. These business rules could include results that should be excluded, for example perhaps a user does not want recommendations to include self-help books or textbooks when providing personalized recommendations for a user. These rules may include an optional set of strategies for filling out result sets when there are not enough correlated items, such as using best sellers in the same genre as the key item.

Finally, in step 340, results are generated. The HPCE may provide results in one of two ways: dynamically, as part of a response to a web service request (JSON), or in batch operation, where data is output to a CSV file, directly to a RDBMS, or any other data sink. Batch operation is typically run over a large set of the data, which is then processed by rules, one of which specifies how to output the data. In batch operation, correlations can be generated for some or all of the objects, subjects or both in the system, and stored in a file for loading into a relational database, spreadsheet, or other means of processing. Dynamic results are returned in real time, via the web services layer, and are represented in JSON. Using the web services layer, results can be incorporated into any website.

As described above, segmentation refers to the methodology by which triples are stored on the various segments of the Segmented Semantic Triplestore. Every triple in the triplestore is stored (indexed) twice: as {subject(stype, sitem), action, object(otype, oitem)} and as {object′(otype, oitem), reverse action, subject′(stype, otype)}. Note that the notation object′ is used to denote an object which occurs on the “left hand side”, and subject′ to denote an object which occurs on the “right hand side”. For the purposes of segmentation, it is the values on the “right hand side” which are significant. This is so the triple can be looked up either by subject or object. The rule for storing triples is that each storing of the triple, stores the triple so that every object(otype, oitem) and every subject′(stype, sitem) is stored on the same segment. For example, considering the triples {subject(1, 1), action, object(1, 2)} and {subject(1, 2), action, object(1, 1)}, there are actually 4 components to store. The rule by which a segment is determined may be arbitrary, but for this simple triplestore, (which is configured with 2 segments, 0 and 1) even item ids will be stored on segment 0 and odd item ids will be stored on segment 1. Thus the triple components {subject(1, 1), action, object(1, 2)} and {object′(1, 1), action, subject′(1, 2)} would be stored on segment 0 (the object and subject′ ids are even) and the triple components {subject(1, 2), action, object(1, 1)} and {object′(1, 2), action, subject′(1, 1)} would be stored on segment 1 (the object and subject′ ids are odd). This methodology can be generalized to ItemID modulo number of segments yields the segment number, however, it is important to realize that any segmentation algorithm is valid, so long as all triples with each individual object(otype, oitem) and subject′(stype, sitem) reside on the same segment.

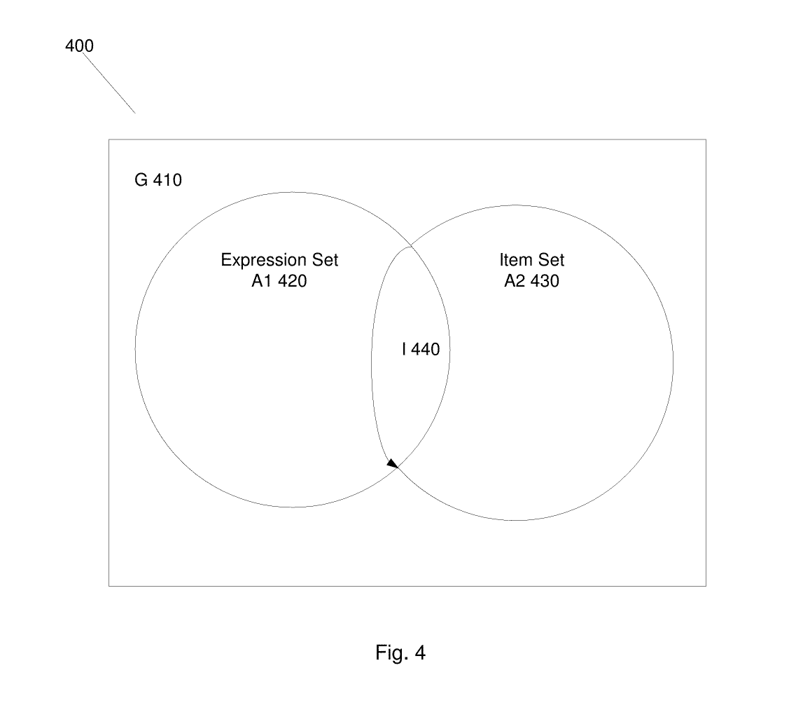

Considering the correlation searches in more detail. The HPCE computes correlation metrics based on 4 basic values: A1, A2, I and G. FIG. 4 shows the 4 basic values in a graphical set format 400. Before describing the basic values in more detail, it should be considered that the sets, as shown, are generated by both the expression and the target object. The expression and the target are both of the same class, e.g., subjects or objects, and the sets are of an opposite class, e.g., an object target item generates a set of subjects (the subjects which have a matching action with this target item).

The value G 410 (universe) is the total number of items that could appear in the generated sets based on the TypeSet that is used. The value A1 420 is the set generated by the expression. The value A2 430 is the set generated by the target. Finally, the value I 440 is the number of times an item appears in the set intersection, e.g., as an item may appear more than once. The primary purpose of the triplestore is to facilitate the computation of these values.

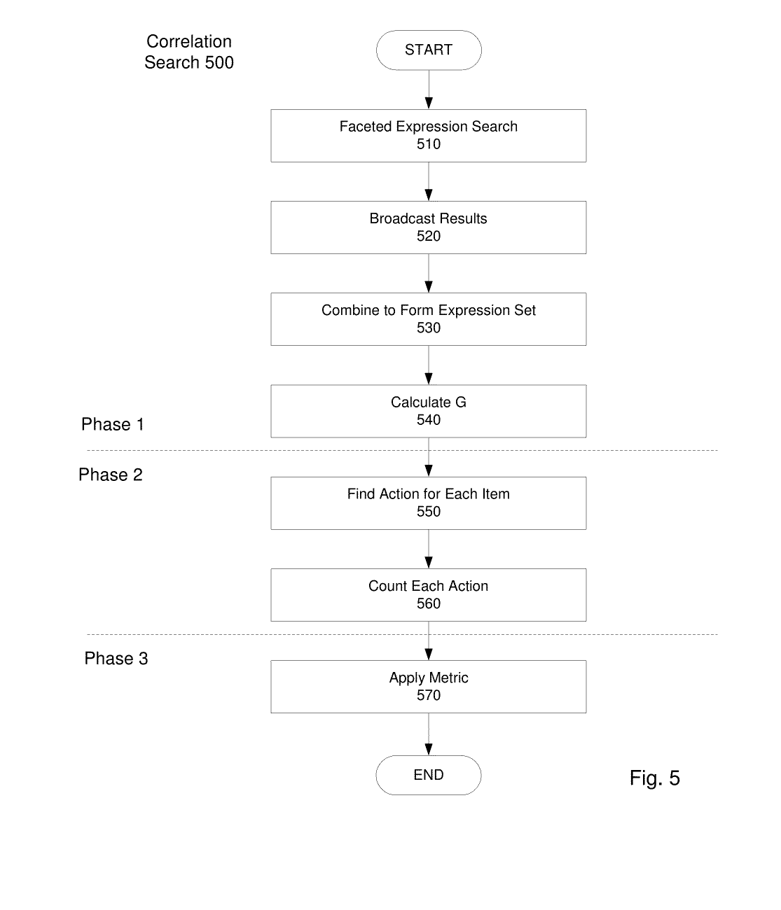

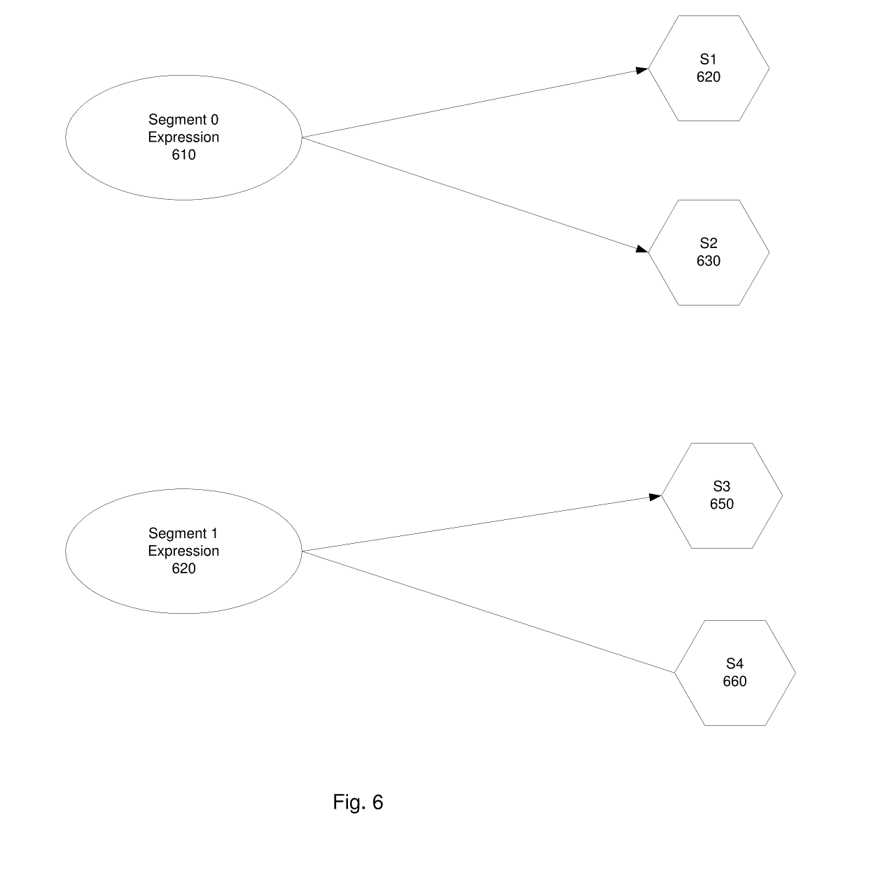

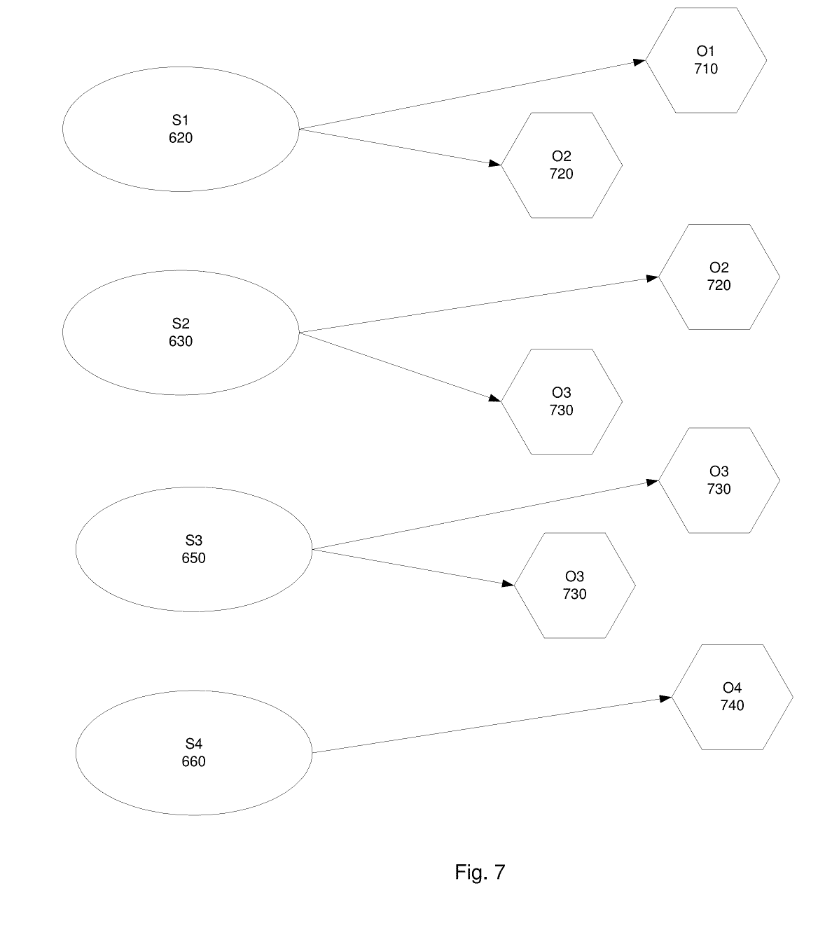

FIG. 5 is an exemplary method 500 for performing a correlation search. The exemplary method will be described with reference to the graphical set format 400 and FIGS. 6 and 7 described in greater detail below. The exemplary method 500 will also be described with reference to the following exemplary triplestore that has exemplary data as follows:
{subject(1, 1), attribute, object(1, 1)}
{subject(1, 2), attribute, object(1, 1)}
{subject(1, 3), attribute, object(1, 1)}
{subject(1, 1), attribute, object(1, 2)}
{subject(1, 2), attribute, object(1, 3)}
{subject(1, 3), attribute, object(1, 4)}
{subject(1, 4), attribute, object(1, 5)}

As described above, the exemplary embodiments may include one segment or many segments. The value of the segmentation methodology is in performing the computation of the 4 values in parallel on many different segments. The exemplary method 500 will be described with reference to a simple system that includes two segments (segment 0 and segment 1). However, those skilled in the art will understand that the exemplary method 500 may be extended to any number of segments. In the present example, it will be considered that even item numbers are stored on segment 0 and odd item numbers are stored on segment 1. This results in the following segmentation of the example data:
On segment 0
{subject(1, 1), attribute, object(1, 2)}
{subject(1, 3), attribute, object(1, 4)}
{object′(1, 1), attribute, subject′(1, 2)}
{object′(1, 3), attribute, subject′(1, 2)}
{object′(1, 5), attribute, subject′(1, 4)}
On segment 1
{subject(1, 1), attribute, object(1, 1)}
{subject(1, 2), attribute, object(1, 1)}
{subject(1, 3), attribute, object(1, 1)}
{subject(1, 2), attribute, object(1, 3)}
{subject(1, 4), attribute, object(1, 5)}
{object′(1, 1), attribute, subject′(1, 1)}
{object′(1, 1), attribute, subject′(1, 3)}
{object′(1, 2), attribute, subject′(1, 1)}
{object′(1, 4), attribute, subject′(1, 3)}

It should be clear that both “halves” do not have to be on the same segment, it is strictly the “right hand side” which determines which segment a triple component resides on.

In step 510, a faceted expression search is performed. Examples of faceted expression searches and the syntax for such searches were provided above. In this example, it may be considered that the search is issued with the expression (object(1, 2)+object(1, 3)+object(1, 4)) (the+sign may be considered as “OR” or “UNION”). The faceted expression search is performed on each segment to generate a segment specific set of expression results. FIG. 6 shows a graphic representation of an example faceted expression search. Specifically, the Segment 0 expression search 610 yields two results S1 620 and S2 630 and the Segment 1 expression search 640 yields two results S3 650 and S4 660.

Returning to the sample data, the step 510 will determine the set of subjects that satisfy the expression. In this case it is subject(1, 1), subject(1, 2), and subject(1, 3). These subjects all have actions on one of the elements of the expression. It may be quickly determined by finding all elements that have an {object′(1,2), attribute, X), where X is all subject′ elements for which the relation is in the triplestore. This is repeated for object′(1, 3) and object′(1,4). The result of this lookup will be the expression set A1 420.

Again, this step 510 is performed for each of Segment 0 and Segment 1. As the triple is “looked up” by the “left hand side” this means “right hand sides” are unique for any lookup on a segment. In this example, in step 510, on segment 0, the expression (object(1,2)+object(1, 3)+object(1, 4) yields only subject(1,2). On segment 1, the expression yields subject(1, 1) and subject(1, 3).

In step 520, each segment broadcasts the results of its expression search to the other segments. Thus, referring to FIG. 6, the Segment 0 broadcasts the results S1 620 and S2 630 to the Segment 1 and the Segment 1 broadcasts the results S3 650 and S4 660 to the Segment 0. In the exemplary set of data provided above, the segment 0 broadcasts the result subject(1,2) to segment 1 and segment 1 broadcasts the results subject(1, 1) and subject(1, 3) to segment 0.

In step 530, each segment combines its own results with the results that it has received from other segments to create the expression set 420. Thus, each segment will have a copy of the complete expression set 420. For example, in the graphic representation of FIG. 6, Segment 0 will combine the results S1 620 and S2 630 generated by Segment 0 with the results S3 650 and S4 660 that Segment 0 received from Segment 1 to create an expression set that includes results S1 620, S2 630, S3 650 and S4 660.

Similarly, Segment 1 will perform the same combination and create the same expression set.

With respect to the exemplary data, the segment 0 will combine the segment 0 result subject(1,2) with the results subject(1, 1) and subject(1, 3) received from segment 1. This will result in the following expression set created by segment 0:
a. subject(1,2)
b. subject(1, 1)
c. subject(1, 3)
   It should be clear from the above discussion that segment 1 will create the same expression set.

In step 540, each segment broadcasts the total number of subjects it has as right hand sides on its local store. These are summed at each node and are the value G 410. Referring to the exemplary data, the value G 410 would be 7, because segment 0 has 3 subjects as right hand sides and because segment 1 has 4 subjects as right hand sides.

It may be considered that the steps 510-540 are a first phase of the correlation search. The first phase includes synchronization between the different segments. The duration of the first phase is the primary limiting factor in the time to process the search and the duration is proportional to the value of the expression set 420 and the complexity of the expression that is used.

The next steps 550-560 may be considered the second phase of the correlation search and these steps may be performed on each of the segments without any intercommunication between the segments. In step 550, for each of the items generated by the first phase (i.e., each of the results in the expression set), find all items for which there is an action from that item. Again, since each segment will include the same expression set 420, this step may be performed on each segment independent of the other segments.

FIG. 7 shows a graphic representation of an example action search. As stated above, this step is performed at each segment and therefore, the example shown in FIG. 7 may be considered to be performed by one segment, e.g., Segment 0. In this example, Segment 0 has the complete expression set 420 that includes results S1 620, S2 630, S3 650 and S4 660. In this example, S1 620 has actions O1 710 and O2 720; S2 630 has actions O2 720 and O3 730; S3 650 has actions O3 730 and O3 730; and S4 660 has action O4 740. These examples should suffice to show that the same action may be included for different items, that the same action may be performed multiple times by the same item, etc. It should be noted that the same step will be performed by Segment 1 using the same expression set 420, but the results may be different because the actions that are stored in the triplets of Segment 1 will be different.

To continue the example with the exemplary data set, it should be clear that segment 0 will generate action:
a. object (1,2) and segment 1 will generate actions:
b. object (1,1)
c. object (1,1)
d. object (1,1)
e. object (1,3)

In step 560, the number of actions for each item may be counted. Referring to the example of FIG. 7, the action O1 710 occurs 1 time, the action O2 720 occurs 2 times, the action O3 730 occurs 3 times and the action O4 740 occurs 1 time. As described above, the value I 440 is the number of times an item appears in the set intersection, e.g., as an item may appear more than once. Thus, the counts from step 550 is the I 440 value.

Continuing with the example date, the count for segment 0 is:
a. object (1,2)—1

and the count for segment 1 is:
b. object (1,1)—3
c. object (1,3)—1

The above examples provided the manner for calculating the G 410 value, the A1 420 value and the I 440 value. The A2 430 value may be stored by each segment because each item is a right hand side on only one segment, therefore each segment may store the set A2 430 for each item that is a right hand side.

A number of useful values, familiar to those skilled in the art, can be computed from the 4 values, for instance given X an element of R, A2/G is the observed probability of X occurring. I/A1 is the probability of R occurring in this expression, and, if greater that the overall probability, indicates a positive correlation with the expression. In our example, for object(1, 1) A1=3, I=3, A2=3, G=4. The overall probability of object(1,1) occurring is 0.75 (3/4) whereas the occurrence in the expression is 1.0.

In step 570, a metric may be applied to the results. As described above, any type of metric that uses the four values may be applied, depending on the problem that is being addressed. Once the 4 values are computed, a correlation value can be computed using any of several metrics based on the 4 values, and the elements of R can be sorted by most relevant value. In the exemplary HPCE, the top N elements of R are sent to the segment that initiated the query, and are combined to be in sorted order and are reported to the requester. Thus, at the end of the process 500, the correlation search results will be determined.

Assuming an implementation of a segmented semantic triplestore consisting of data of the form Subject->Object and Object->Subject, where subject and object are differently typed entities, many correlation metrics can be computed between Object(1) and Object(2) based on 4 basic quantities. A1: the number of Subjects for which the relation Object(1)->Subject(X) is true. A2: the number of subjects for which the relation Object(2)->Subject(X) is true. I: the number of Subjects for which the relationship Object(1)->Subject(X) AND Object(2)->Subject(X) is true. G: The total number of Subjects. It should be clear to those skilled in the art that many correlation metrics can be computed from these 4 values: thus, an efficient correlation computer should be able to compute these 4 values efficiently and in parallel. This invention proposes segmenting the data into K segments, where each segment is a data store containing relations of the form Object->Subject and Subject->Object. A relation Object(A)->Subject(B) is assigned to a segment k in such a way that every such relationship where Subject(B) occurs on the right hand side is assigned to the same segment k. Conversely, for the relations Subject(A)->Object(B), each such relation is assigned to a segment k such that every relation for which Object(B) occurs on the right hand side is assigned to the same segment k. An additional data item is that for each subject or object occurring on the right hand side (and always occurring in the same segment), the system maintains a count of occurrences for that object, as well as the total number of subjects and objects on that segment.

Parallel computation of the 4 basic values is then simple, and occurs in 2 phases. To compute the correlation between Object(1) and all Object(Y), each segment first creates a list of every Subject(X) for which Object(1)->Subject(X) is true. The segment then broadcasts this list to every other segment along with the total number of Subjects on the broadcasting segment, and receives these broadcasts from the other segments. This is the last point of synchronization between segments. A1 is the total number of items broadcast (The segmentation principle above means each segment's broadcast list is unique). G is the sum of the segment counts broadcast by each segment. The other 2 Values are computed as follows. For each Subject(Z) which was either computed in Phase 1 by this segment or was broadcast to us by another segment, compute all Object(Y) along with a count of how many times in this process a particular Object occurs. This count is the value I for each Object(Y). As each Object(Y) is a right hand side only on this segment, the count of its occurrences is A2. We now have (on this segment) all 4 values for every Object(Y) which has a nonzero I, and occurs on this segment. Repeating this (in parallel) on each segment yields every result in the system.

This provides a practical method to compute correlations dynamically, in real time, exploiting parallelism and scaling which is speed limited only by the value of the A1 number for a particular correlation search. Our experience is that this method can compute correlations where that number is in the millions in a few seconds, making this methodology practical for computing correlations in data sets with billions of total relations.

Those skilled in the art will understand that the above-described exemplary embodiments may be implemented in any suitable software or hardware configuration or combination thereof. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
storing a plurality of data points in a form Subject->Object and Object->Subject, where subject and object are differently typed entities, wherein the data points are stored in a plurality of segments;
performing an expression search in each segment to identify an expression set of objects or subjects which can be viewed as the right hand side of the expression;
determining, for each segment, actions corresponding to each of the data points in the expression set;
determining a count of each of the actions; and
applying a metric to each of the expression set, the actions and the count to obtain a result.
